(19) United States
(12) Patent Application Publication
(10) Pub. No.: US 2011/0228056 A1
(43) Pub. Date: Sep. 22, 2011

(54) ELECTRONIC APPARATUS, VIDEO OUTPUT SYSTEM, AND VIDEO OUTPUT METHOD

(76) Inventor: Hideaki Okumoto, Fukaya-shi (JP)

(21) Appl. No.: 13/027,863

(22) Filed: Feb. 15, 2011

(30) Foreign Application Priority Data
Mar. 19, 2010 (JP) 2010-065236

(51) Int. Cl. H04N 13/04

(52) U.S. Cl. 348/51; 348/E13.001

(57) ABSTRACT

According to one embodiment, an electronic apparatus includes a video output module, a receiving module, and an image quality adjusting module. The video output module is configured to output 2D video and 3D video selectively. The receiving module is configured to receive a wearing state signal indicating whether or not a user wears shutter glasses. The image quality adjusting module is configured to determine a first image quality adjustment amount when the video output module outputs the 2D video and the wearing state signal indicates that the user wears the shutter glasses, and to determine a second image quality adjustment amount when the video output module outputs the 2D video and the wearing state signal indicates that the user does not wear the shutter glasses. The second image quality adjustment amount is different from the first image quality adjustment amount.

### CROSS REFERENCE TO RELATED APPLICATION(S)

This application is based upon and claims the benefit of priority from Japanese Patent Application No. 2010-065236 filed on Mar. 19, 2010, the entire contents of which are incorporated herein by reference.

### BACKGROUND

1. Field

Embodiments described herein relate generally to an electronic apparatus, a video output system, and a video output method.

2. Description of the Related Art

With the recent technical development, electronic apparatus have been proposed which display a motion picture by the frame-sequential method and can provide 3D video to users who wear shutter glasses.

In frame-sequential 3D video providing methods, each of the left-eye lens and the right-eye lens of the shutter glasses transmits and stops light repeatedly. Therefore, the user may not be able to view video being displayed on an electronic apparatus with the same image quality as of the displayed video itself. For example, because the lenses of the shutter glasses stop light, the luminance of video as recognized by the user may be approximately a half of that of displayed video.

When an electronic apparatus is outputting 2D video, if both lenses of the shutter glasses are kept transparent, the user can view the 2D video without sensing a flicker that might otherwise be sensed due to the light transmission/stop switching. However, in the case where, for example, each lens is driven by a liquid crystal shutter, even if both lenses of the shutter glasses are kept transparent, the image quality of video as recognized by the user may be different from that of video as output from the electronic apparatus because of the presence of the liquid crystals.

That is, when the user views 2D video wearing the shutter glasses, video as recognized by the user may be different from displayed video.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary conceptual view showing a video output system according to an embodiment;

FIG. 2 is an exemplary block diagram showing internal configurations of a DTV and shutter glasses according to the embodiment;

FIG. 3 is an exemplary block diagram showing a part of the DTV relating to image quality adjustment;

FIG. 4 is an exemplary conceptual view showing an image quality setting table in the embodiment; and

FIG. 5 is an exemplary flowchart showing an image quality adjustment processing which is executed for video display by the DTV according to the embodiment.

### DETAILED DESCRIPTION

In general, according to one embodiment, an electronic apparatus includes a video output module, a receiving module, and an image quality adjusting module. The video output module is configured to output 2D video and 3D video selectively. The receiving module is configured to receive a wearing state signal indicating whether or not a user wears shutter glasses. The image quality adjusting module is configured to determine a first image quality adjustment amount when the video output module outputs the 2D video and the wearing state signal indicates that the user wears the shutter glasses, and to determine a second image quality adjustment amount when the video output module outputs the 2D video and the wearing state signal indicates that the user does not wear the shutter glasses. The second image quality adjustment amount is different from the first image quality adjustment amount.

An exemplary embodiment will be hereinafter described with reference to the drawings.

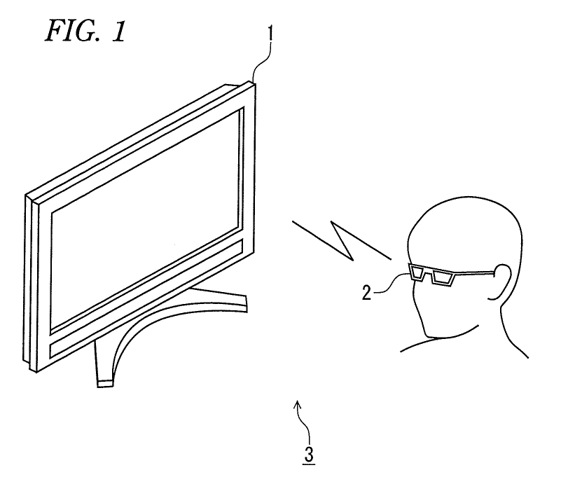

FIG. 1 is an exemplary conceptual view of a video output system 3 according to the embodiment. As shown in FIG. 1, the video output system 3 is composed of a digital TV receiver (DTV) 1 and shutter glasses 2.

The DTV 1 is an example electronic apparatus according to the embodiment. The DTV 1 alternately displays left-eye images and right-eye images having a parallax, whereby the user who wears the shutter glasses 2 can see 3D video (frame-sequential method). Although the embodiment employs the DTV 1 as an example electronic apparatus, the invention is not limited to such a case. Any of various electronic apparatus such as a DVD (digital versatile disc) player, an HDD (hard disk drive) player, a set-top box (STB), and a personal computer (PC) can be employed.

The shutter glasses 2 are equipped with a left-eye lens and a right-eye lens each of which is provided with a liquid crystal shutter capable of stopping light. The combination of the lens and the liquid crystal shutter will be referred to as a lens unit below. The shutter glasses 2 provide the user with 3D video in such a manner that the shutters of the left-eye lens unit and the right-eye lens unit are opened or closed at different time points based on a shutter opening/closing signal received from the DTV 1. For example, when a left-eye image is displayed on the DTV 1, the shutter glasses 2 allow only the left eye of the user to see the left-eye image by closing the shutter of the right-eye lens unit (rendering it opaque) and opening the shutter of the left-eye lens unit (rendering it transparent) based on a shutter opening/closing signal received from the DTV 1. When a right-eye image is displayed on the DTV 1, the shutter glasses 2 allow only the right eye of the user to see the right-eye image by closing the shutter of the left-eye lens unit (rendering it opaque) and opening the shutter of the right-eye lens unit (rendering it transparent) based on the shutter opening/closing signal. With this operation, the user can recognize, as 3D video, the video being displayed. The shutter glasses 2 can detect their wearing state of the user, and transmit the DTV 1 a wearing state signal indicating the detected wearing state in response to a request from the DTV 1.

The principle of 3D vision will be described below in more detail. A human usually sees an object with his or her left eye and right eye which are located at different positions, and a parallax exists between images taken by the left eye and the right eye. The human can recognize the object as a 3D object by combining the images taken by the left eye and the right eye and having the parallax in his or her brains. Therefore, it is possible to cause a user to recognize video as 3D video by causing the user to see a left-eye image and a right-eye image having a parallax through the respective eyes. Operating in the above-described manner on this principle, the shutter glasses 2 cause the user to recognize, as 3D video, video displayed by the DTV 1.

The video output system 3 is composed of the DTV 1 and the shutter glasses 2. The user who views video being displayed on the DTV 1 while wearing the shutter glasses 2 can recognize it as 3D video.

As described above, each lens unit of the shutter glasses 2 is provided with the liquid crystal shutter. Therefore, even when the shutter of each lens unit is rendered transparent, not all, of incident light passes through the lens unit and light having a prescribed frequency is reflected or absorbed by the lens unit. As a result, for example, when the user who wears the shutter glasses 2 sees an object through the lens units, the object looks in such a manner that a certain color is enhanced (e.g., the object looks yellowish) or looks a little darker even if the shutters are kept transparent. Because of this phenomenon, when 2D video is displayed by the DTV 1, the image quality of video supplied to the user through the shutter glasses 2 is different from that of video being displayed by the DTV 1 even if the user views the video with both liquid crystal shutters kept transparent.

The DTV 1 according to the embodiment can improve the image quality of video supplied to the user when the user watches video on the DTV 1 with both liquid crystal shutters of the shutter glasses 2 kept transparent.

Next, the internal configurations of the DTV 1 and the shutter glasses 2 will be described in detail.

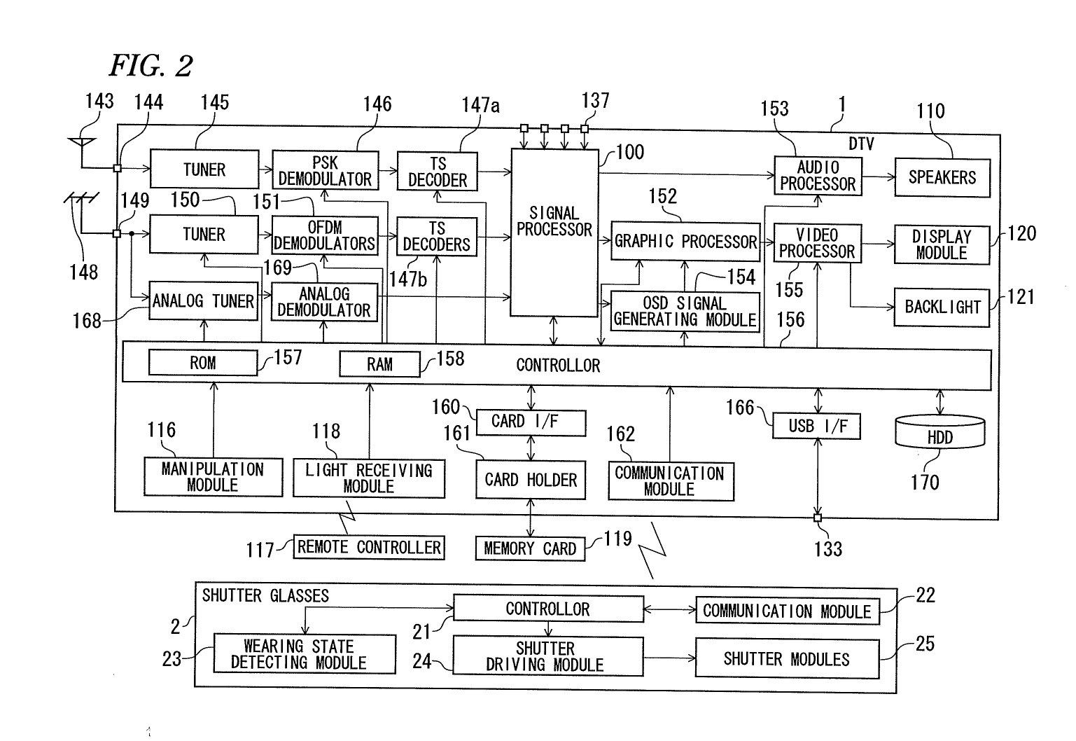

FIG. 2 is a block diagram showing example internal configurations of the DTV 1 and the shutter glasses 2 according to the embodiment.

The internal configuration of the DTV 1 will be described first.

The DTV 1 is equipped with a controller 156 for controlling operations of its individual components. The controller 156 incorporates a CPU (central processing unit) etc. The controller 156 activates a system control program and various processing programs stored in a ROM (read-only memory) 157 in advance in response to an operation signal that is input through a manipulation module 116 or transmitted from a remote controller 117 and received by a light receiving module 118. The controller 156 controls operations of the individual components of the DTV 1 according to the activated programs using a RAM (random access memory) 158 as a work memory.

Satellite digital TV broadcast signals received by a BS/CS digital broadcast receiving antenna 143 are supplied to a satellite digital broadcast tuner 145 via an input terminal 144. The tuner 145 tunes in to one of the received digital broadcast signals and supplies the thus-selected digital broadcast signal to a PSK (phase shift keying) demodulator 146. The PSK demodulator 146 demodulates the digital broadcast signal into a transport stream (TS) and supplies the transport stream to a TS decoder 147a. The TS decoder 147a decodes the transport stream into a digital signal containing a digital video signal, a digital audio signal, and a data signal and outputs it to a signal processor 100. The digital video signal is a digital signal relating to video that can be output by the DTV 1, and the digital audio signal is a digital signal relating to audio that can be output by the DTV 1. The data signal is a digital signal that represents information relating to broadcast programs and contains, for example, program-related information which is information to be used when the DTV 1 generates an electronic program guide (EPG). The program-related information contains a title, detailed information, a program start time, a program end time, etc. of each broadcast program.

Terrestrial digital TV broadcast signals received by a terrestrial digital broadcast receiving antenna 148 are supplied to a terrestrial digital broadcast tuner 150 via an input terminal 149. The tuner 150 tunes in to part of the received digital broadcast signals and supplies the thus-selected digital broadcast signals to respective OFDM (orthogonal frequency division multiplexing) demodulators 151. The OFDM demodulators 151 demodulate the digital broadcast signals into transport streams and supplies the transport streams to respective TS decoders 147b. The TS decoders 147b decode the transport streams into digital video signals, digital audio signals, etc. and output those signals to the signal processor 100.

The antenna 148 can also receive terrestrial analog TV broadcast signals. The received terrestrial analog TV broadcast signals are distributed by a distributor (not shown) and supplied to an analog tuner 168. The analog tuner 168 tunes in to one of the received analog broadcast signals and supplies the thus-selected analog broadcast signal to an analog demodulator 169. The analog demodulator 169 demodulates the analog broadcast signal and outputs a resulting analog broadcast signal to the signal processor 100. If, for example, a CATV (common antenna television) tuner is connected to the input terminal 149 to which the antenna 148 is connected, the DTV 1 allows the user to also view CATV broadcast programs.

The signal processor 100 performs proper signal processing on a digital signal that is output from the TS decoder 147a or 147b or the controller 156. More specifically, the signal processor 100 separates the digital signal into a digital video signal, a digital audio signal, and a data signal. The separated video signal and audio signal are output to a graphic processor 152 and an audio processor 153, respectively. Furthermore, the signal processor 100 converts a broadcast signal that is output from the analog demodulator 169 into a video signal and an audio signal having prescribed digital formats. Those digital video signal and audio signal are output to the graphic processor 152 and the audio processor 153, respectively. Still further, the signal processor 100 performs prescribed digital signal processing on an input signal that is supplied via a line input terminal 137.

An OSD (on-screen display) signal generating module 154 generates, under the control of the controller 156, an OSD signal for display of a UI (user interface) picture or the like. A data signal that is separated from a digital broadcast signal by the signal processor 100 is converted by the OSD signal generating module 154 into an OSD signal having a proper format, which is output to the graphic processor 152.

The graphic processor 152 decodes the digital video signal that is output from the signal processor 100. The decoded video signal is combined with (superimposed on) the OSD signal that is output from the OSD signal generating module 154, and a resulting signal is output to a video processor 155. The graphic processor 152 can also select and output the decoded video signal or the OSD signal to the video processor 155.

The video processor 155 performs image quality correction on the output signal of the graphic processor 152 and converts a resulting signal into an analog video signal having such a format as to be displayable by a display module 120. The analog video signal produced by the video processor 155 is displayed on the display module 120.

The display module 120, which is an LCD (liquid crystal display), displays an image using a liquid crystal. A backlight 121 illuminates the display module 120 from behind. The luminance of displayed video can be adjusted by controlling the intensity or the illumination time of light that is emitted from the backlight 121.

The audio processor 153 converts the received audio signal into an analog audio signal having such a format as to be played back by speakers 110. The analog audio signal is thus output to and played back by the speakers 110.

A card holder 161 is connected to the controller 156 via a card interface (I/F) 160. A memory card 119 can be inserted into the card holder 161. The memory card 119 is a storage medium such as an SD (secure digital) memory card, an MMC (multimedia card), or a CF (compact flash) card. The controller 156 can perform information writing and reading, via the card I/F 160, on the memory card 119 that is inserted in the card holder 161.

A USB (universal serial bus) terminal 133 is connected to the controller 156 via a USB I/F 166. The USB terminal 133 is used as a general USB-compatible port. A cell phone, a digital camera, a card reader/writer for any of various memory cards, an HDD, a keyboard, etc. can be connected to the USB terminal 133 via a hub, for example. The controller 156 can communicate (exchange information) with each device that is connected to the USB terminal 133. The connection cable 3 can be connected to the USB terminal 133, and FIG. 2 shows a case that the connection cable 3 is connected to the USB terminal 133 and a terminal 26 of the shutter glasses 2.

An HDD 170, which is a magnetic storage medium incorporated in the DTV 1, has a function of storing various kinds of information to be held by the DTV 1.

A communication module 162, which is an infrared communication module, for example, can perform a wireless communication with the shutter glasses 2 by infrared light. The controller 156 has a function of detecting the display state of a left-eye image and a right-eye image of 3D video and causing the communication module 162 to transmit a shutter opening/closing signal to the shutter glasses 2 based on the detected display state of the 3D video. The signal processor 101 causes the communication module 162 to transmit an opening/closing signal to the shutter glasses 2 so that the right-eye shutter 7 of the shutter glasses 2 is opened (rendered transparent) and the left-eye shutter 6 is closed (rendered opaque) when the display module 120 displays a right-eye image and the right-eye shutter 7 is closed (rendered opaque) and the left-eye shutter 6 is opened (rendered transparent) when the display module 120 displays a left-eye image. Furthermore, the communication module 162 can receive a wearing state signal that is transmitted from a communication module 22 of the shutter glasses 2 and indicates a wearing state of the shutter glasses 2 of the user. The wearing state signal will be described later.

Next, the internal configuration of the shutter glasses 2 will be described.

A controller 21 incorporates an MPU (microprocessing unit) and controls the entire shutter glasses 2. The controller 21 can exchange signals with individual components connected to it.

The communication module 22, which is an infrared communication module, for example, can perform a wireless communication with the DTV 1 by infrared light. Although in the embodiment both of the communication modules 162 and 22 are infrared communication modules and the DTV 1 and the shutter glasses 2 communicate with each other by infrared light, the invention is not limited to such a case. For example, each of the communication modules 162 and 22 can be a communication module that complies with any of various wireless or wired communication standards as typified by the Bluetooth (registered trademark) radio communication standard. The communication module 22 has a function of receiving an opening/closing signal that is transmitted from the communication module 162 of the DTV 1 and a function of transmitting a wearing state signal indicating a wearing state of the shutter glasses 2 of the user.

A wearing state detecting module 23 is a switch having a function of detecting whether or not the user wears the shutter glasses 2. For example, in the embodiment, the wearing state detecting module 23 is a push switch which is provided at a position corresponding to a nose pad of the shutter glasses 2. While the user wears the shutter glasses 2, the wearing state detecting module 23 is in contact with the nose of the user and detects that it is pushed resultantly. Although in the embodiment the wearing state detecting module 23 is push switch which is provided at a position corresponding to a nose pad of the shutter glasses 2, the invention is not limited to such a case. The wearing state detecting module 23 can be implemented in other various forms. For example, the wearing state detecting module 23 may be a sensor such as an electrostatic touch sensor. The position of the wearing state detecting module 23 is not limited to a position where it is in contact with the nose of the user, and may be a position it is in contact with an ear of the user. Furthermore, the wearing state detecting module 23 is not limited to the case of detecting contact with part of the face of the user and may be a switch that the user is to push to inform the DTV 1 whether or not the user wears the shutter glasses 2. In this case, the wearing state detecting module 23 is provided on part of the frame of the shutter glasses 2 as a switch and outputs wear/non-wear information through toggle switching when pushed by the user (e.g., a power switch for powering on/off the shutter glasses 2). The wearing state detecting module 23 supplies wearing state information to the controller 21 in response to a wearing state information supply request from the controller 21.

A shutter driving module 24 is a liquid crystal driving device for driving the shutter modules 25 each of which uses a liquid crystal. The shutter driving module 24 has a function of driving the left-eye and right-eye liquid crystal shutters of the shutter modules 25 according to an opening/closing signal that is transmitted from the DTV 1.

Provided in the respective lens units of the shutter glasses 2 and driven by the shutter driving module 24, the shutter modules 25 switch the light transmission/stop of the left-eye and right-eye lens units. The shutter modules 25 are transparent while the shutter glasses 2 receive no opening/closing signal.

The shutter glasses 2 receive, by means of the communication module 22, a signal that is transmitted from the communication module 162 of the DTV 1 and perform a prescribed operation corresponding to the received signal. In the embodiment, the DTV 1 transmits the shutter glasses 2 two kinds of signals, which are an opening/closing signal for controlling the light transmission/stop of the shutter glasses 2 and a wearing state signal transmission request which is a signal for requesting transmission of a wearing state signal indicating a wearing state of the shutter glasses 2 of the user.

When the communication module 22 of the shutter glasses 2 receives an opening/closing signal, based on the received signal the controller 21 instructs the shutter driving module 24 to drive the shutter modules 25. The shutter driving module 24 switches the light transmission/stop of the shutter modules 25 according to the received instructions. When the communication module 22 of the shutter glasses 2 receives a wearing state signal transmission request, the controller 21 acquires wearing state information from the wearing state detecting module 23 and causes the communication module 22 to transmit a resulting wearing state signal. Although in the embodiment the controller 21 acquires wearing state information from the wearing state detecting module 23 when receiving a wearing state signal transmission request, the invention is not limited to such a case. For example, when user puts on or off the shutter glasses 2, the wearing state detecting module 23 may detect that action and supply corresponding wearing state information to the controller 21. In this case, the controller 21 holds the received wearing state information in its own cache and sends out a corresponding wearing state signal in response to a wearing state signal transmission request that is transmitted from the DTV 1.

In the embodiment, the DTV 1 switches the image quality of video displayed by itself according to the kind of the displayed video and the content of a wearing state signal transmitted from the shutter glasses 2. That part of the DTV 1 which mainly relates to this operation will be described below.

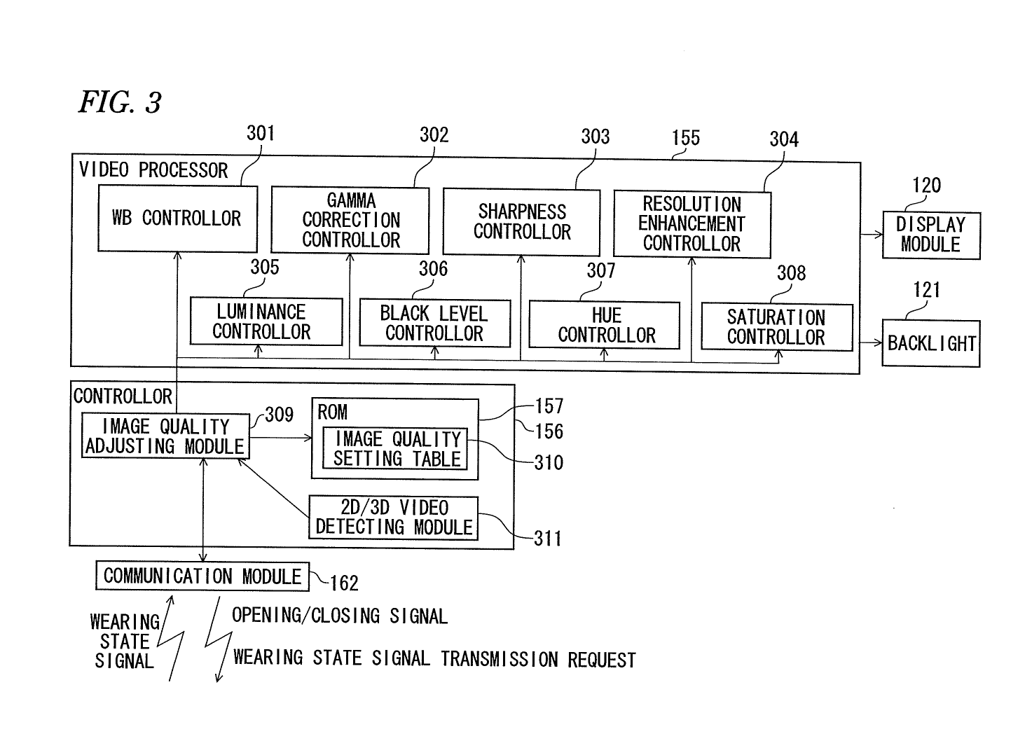

FIG. 3 is a block diagram showing that part of the DTV 1 which relates to image quality adjustment. As shown in FIG. 3, the video processor 155 includes a WB controller 301, a gamma correction controller 302, a sharpness controller 303, a resolution enhancement controller 304, a luminance controller 305, a black level controller 306, a hue controller 307, and a saturation controller 308. The display module 120 and the backlight 121 are connected to the video processor 155. The controller 156 includes an image quality adjusting module 309, the ROM 157, and a 2D/3D video detecting module 311. The ROM is stored with an image quality setting table 310. The communication module 162 is connected to the controller 156.

First, the individual components of the video processor 155 will be described.

The WB controller 301 has a function of correcting the color temperature of video (image quality adjustment) by adjusting its white balance.

The gamma correction controller 302 has a function of performing gamma correction which is correction for obtaining a more natural display by adjusting a relationship between color data of video and actual output signals.

The sharpness controller 303 has a function of performing sharpness correction of emphasizing image outlines (image quality adjustment).

The resolution enhancement controller 304 has a function of performing video resolution enhancement processing by increasing the number of pixels of an image by estimating pixel values. The resolution enhancement processing includes super-resolution processing, for example.

The luminance controller 305 has a function of adjusting the luminance (brightness) of displayed video. The luminance controller 305 adjusts the luminance by controlling the light quantity, the illumination time, or the like of the backlight 121.

The black level controller 306 has a function of performing, on a video signal, black level control processing which is processing for playing back and displaying dark portions of video.

The hue controller 307 has a function of adjusting hue differences of displayed video.

The saturation controller 308 has a function of adjusting the saturation which is the degree of color vividness of displayed video.

Having the above-configured WB controller 301 to saturation controller 308, the video processor 155 adjusts the image quality of displayed video by displaying video as adjusted by those controllers 301-308 on the display module 120 while controlling the backlight 121.

The 2D/3D video detecting module 311 has a function of detecting whether the video to be displayed on the display module 120 is 2D video or 3D video. Whether the video to be displayed is 2D video or 3D video can be detected (determined) by referring to a header or the like of the video stream. Where the video to be displayed is, for example, video that is input from an external video playing back apparatus or the like, whether the video to be displayed is 2D video or 3D video may be determined based on a signal that is sent from the external apparatus. The 2D/3D video detecting module 311 supplies the image quality adjusting module 309 with information indicating whether the video to be displayed is 2D video or 3D video (i.e., information indicating a type of the video to be displayed).

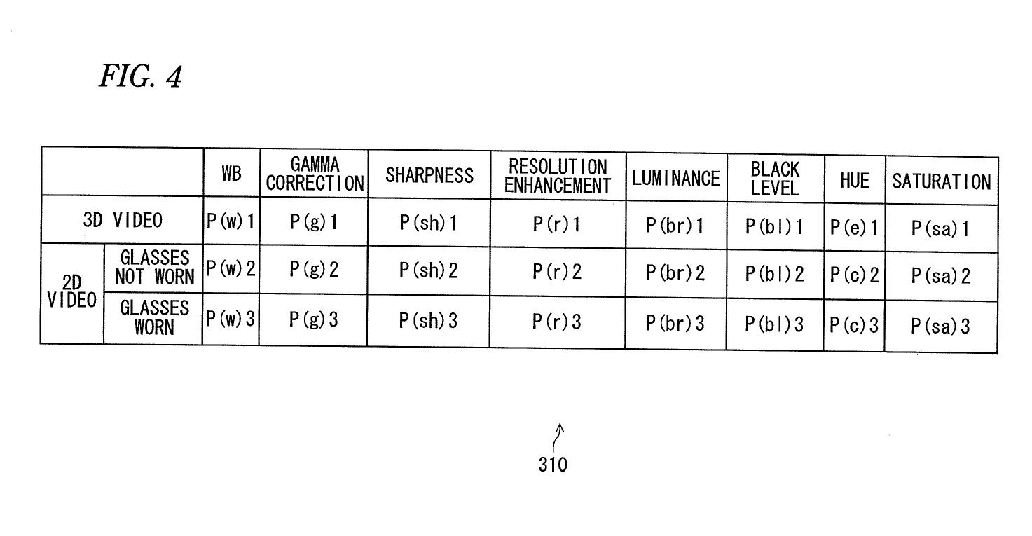

The image quality setting table 310 is table data which is referred to when the image quality adjusting module 309 controls the image quality adjustment amounts. The image quality setting table 310 will be described later with reference to FIG. 4. Although in the embodiment the image quality setting table 310 is stored in the ROM 157, the invention is not limited to such a case. The image quality setting table 310 may be stored in another storage medium such as the HDD 170.

The image quality adjusting module 309 has a function of setting the image quality of video to be displayed according to its type and the wearing state of the shutter glasses 2 of the user. The image quality adjusting module 309 receives a wearing state signal from the shutter glasses 2 via the communication module 162 and acquires wearing state information indicating a wearing state of the user from the received wearing state signal. The image quality adjusting module 309 also receives information indicating a type (2D or 3D) of the video to be displayed from the 2D/3D video detecting module 311. The image quality adjusting module 309 supplies the above-described substantial image quality adjusting controllers 301-308 of the video processor 155 with instruction of image quality adjustment amounts (correction amounts) by referring to the image quality setting table 310 (stored in the ROM 157) using the received pieces of information. Based on the instruction, the video processor 155 performs image quality adjustment processing on frames constituting the video.

FIG. 4 shows an example of the image quality setting table 310 used in the embodiment.

The image quality setting table 310 is table data which contains parameters to be used when the image quality adjusting module 309 controls the above-described controllers of image quality adjustment processing of the video processor 155. In the image quality setting table 310, the parameters are correlated with combinations of each of the substantial image quality adjusting controllers 301-308 of the video processor 155 and each user viewing form.

There are three user viewing forms, that is, under viewing of 3D video, under viewing of 2D video without wearing of the shutter glasses 2, and under viewing of 2D video with wearing of the shutter glasses 2. The image quality adjusting module 309 determines a user viewing form based on wearing state information of the shutter glasses 2 of the user and display video type information, and determines what parameters in the image quality setting table 310 are to be referred to according to the thus-determined user viewing form. For example, if determining that the user is viewing 3D video based on information supplied from the 2D/3D video detecting module 311, the image quality adjusting module 309 controls the image quality by supplying image quality adjustment amounts to the WB controller 301 to the saturation controller 308 of the video processor 155 based on the parameters P(w)1 to P(sa)1.

The parameters in the image quality setting table 310 may be in various forms. For example, the parameters corresponding to the respective user viewing forms may be set independently of each other. The image quality setting table 310 may have no parameters for the user viewing form “under viewing of 2D video without wearing of the shutter glasses 2”, which is an ordinary user viewing form (no image quality adjustments are made, that is, image quality adjustment amounts are zero). In the embodiment, the image quality adjustment amounts are assumed to be zero when no image quality adjustments are made.

Furthermore, the user may be allowed to set the image quality setting table 310. In this case, the controller 156 may be provided with an altering module capable of altering the parameters of the image quality setting table 310. The altering module alters the parameters of the image quality setting table 310 according to an instruction that is made by the user through the remote controller 117, for the like. The user can thus view video with his or her favorite image quality depending on a viewing form.

Next, a description will be made of example image quality adjustment amounts, considered appropriate, of the controllers 301-308 of the video processor 155.

The image quality adjusting module 309 can present the user with video that is close, in color, to original video by correcting the image quality of video that looks yellowish when viewed through the shutter glasses 2 by controlling the white balance adjustment amount of the WB controller 301. In particular, the white balance adjustment is very necessary when 2D video is viewed through the shutter glasses 2.

The image quality adjusting module 309 can present the user with video that is close, in luminance, to original video by increasing the luminance of video that looks dark when viewed through the shutter glasses 2 by controlling the luminance adjustment amount of the luminance controller 305.

When video has a portion that looks dark when viewed through the shutter glasses 2, the image quality adjusting module 309 can present the user with video in which such a portion is made easier to see by controlling the black level using the black level controller 306.

When frame-sequential 3D video is viewed, left-eye images and right-eye images are displayed sequentially and alternately. In particular, where the panel response speed does not have a sufficient time margin with respect to the image display switching speed (the shutter opening/closing speed of the shutter glasses 2) as in the case of display by a liquid crystal panel, there may occur a phenomenon that when a certain image is displayed the immediately preceding image has not disappeared completely from the panel screen yet. This results in a phenomenon called crosstalk that when a certain image is displayed the immediately preceding image for the other eye remains (the image is seen doubly). In particular, when outlines of a displayed image are emphasized, the user sees the outlines as an afterimage and crosstalk is large. In this case, the image quality adjusting module 309 reduces crosstalk adjusts the correction amounts (processing amounts) of the sharpness controller 303 and the resolution enhancement module 304 (reduces the adjustment amount of the sharpness controller 303) so as to prevent excessive emphasis of image outlines.

The image quality adjusting module 309 adjusts the image quality correction amounts according to the user viewing form through the above processing. The parameters of the image quality setting table 310 are set so that such adjustments are appropriate.

Next, an image quality adjustment processing of the DTV 1 will be described.

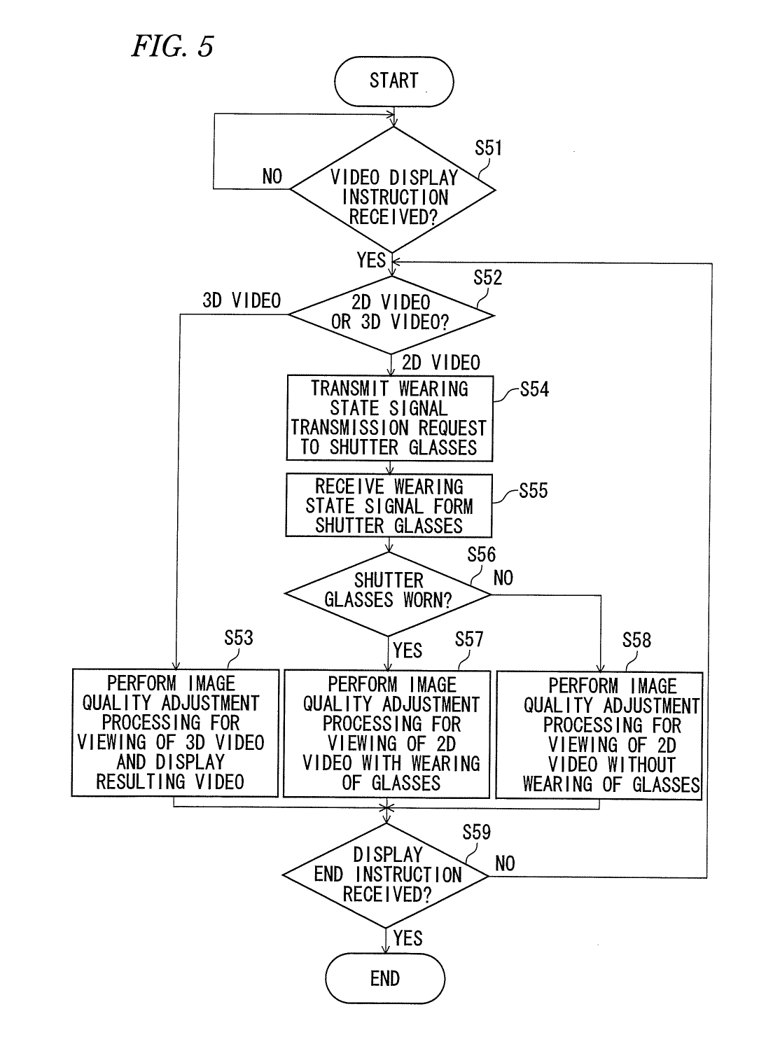

FIG. 5 is a flowchart of an example image quality adjustment processing which is executed for video display by the DTV 1 according to the embodiment.

First, at step S51, the DTV 1 determines whether or not a video display instruction has been received from the remote controller 117 or the like. If no video display instruction has been received (S51: no), the process returns to step S51.

If a video display instruction has been received from the remote controller 117 or the like (S51: yes), the 2D/3D video detecting module 311 detects information indicating whether the video to be displayed is 2D video or 3D video and supplies the detected information to the image quality adjusting module 309. At step S52, the image quality adjusting module 309 determines whether the video to be displayed is 2D video or 3D video based on the received information.

If it is determined at step S52 that the video to be displayed is 3D video, at step S53 the image quality adjusting module 309 controls the image quality by supplying image quality adjustment amounts to the WB controller 301 to the saturation controller 308 of the video processor 155 by referring to the parameters corresponding to the user viewing from “under viewing of 3D video” in the image quality setting table 310. Based on these instructions, the controllers 301-308 of the video processor 155 adjust the image quality and the display module 120 displays resulting adjusted video.

If it is determined at step S52 that the video to be displayed is 2D video, at step S54 the image quality adjusting module 309 transmits a wearing state signal transmission request to the shutter glasses 2 via the communication module 162.

At step S55, the communication module 162 receives a wearing state signal from the shutter glasses 2 and the image quality adjusting module 309 acquires the received wearing state signal. At step S56, the image quality adjusting module 309 determines whether or not the user wears the shutter glasses 2 based on the wearing state signal.

If determining that the user wears the shutter glasses 2 (S56: yes), at step S57 the image quality adjusting module 309 controls the image quality by supplying image quality adjustment amounts to the controllers 301-308 of the video processor 155 by referring to the parameters corresponding to the user viewing form “under viewing of 2D video with wearing of the shutter glasses 2” in the image quality setting table 310. Based on these instructions, the controllers 301-308 of the video processor 155 adjust the image quality and the display module 120 displays resulting adjusted video.

If determining that the user does not wear the shutter glasses 2 (S56: no), at step S58 the image quality adjusting module 309 controls the image quality by supplying image quality adjustment amounts to the controllers 301-308 of the video processor 155 by referring to the parameters corresponding to the user viewing form “under viewing of 2D video without wearing of the shutter glasses 2” in the image quality setting table 310. Based on these instructions, the controllers 301-308 of the video processor 155 adjust the image quality and the display module 120 displays resulting adjusted video.

Upon execution of step S53, S57, or S58, the DTV 1 determines at step S59 whether or not a video display end instruction has been received.

If no video display end instruction has been received (S59: no), the process returns to step S52.

If a video display end instruction has been received (S59: yes), the process is finished.

In the above-described process, the process returns to step S52 and determines the user viewing form unless a video display end instruction is received (S59: no). Therefore, even if the user changes the viewing form while viewing video, the DTV 1 can display video that is suitable for the new user viewing form. The determination of step S52 may be made intermittently at prescribed intervals or with prescribed timing. For example, whether 2D video or 3D video is going to be displayed may be determined upon occurrence of a scene change or the like in the video. In this case, the 2D/3D video detecting module 311 should have a function of detecting a scene change (scene switching detecting module). If determining that a scene change has occurred in the video, the 2D/3D video detecting module 311 detects whether the post-switching video is 2D video or 3D video and supplies a detection result to the image quality adjusting module 309. Based on the received information, the image quality adjusting module 309 determines whether the post-switching video is 2D video or 3D video. Therefore, the DTV 1 can even accommodate switching between 2D video and 3D video due to a scene change, for example; the DTV 1 can provide the user with image quality that is suitable for each of video before the scene switching and video after that. In this case, for example, the DTV 1 can also accommodate a broadcast form that a broadcast program is 3D video and each commercial message (CM) is 2D video. The user can view video with image quality that is suitable for each viewing form while continuing to wear the shutter glasses 2.

Although in the embodiment the shutter glasses 2 transmits a wearing state signal in response to a wearing state signal transmission request from the DTV 1, the invention is not limited to such a case. The video output system 3 may be such that the shutter glasses 2 transmits a wearing state signal even while not receiving a wearing state signal transmission request from the DTV 1. In this case, when the wearing state detecting module 23 of the shutter glasses 2 detects a change in the wearing state of the shutter glasses 2 of the user, the controller 21 voluntarily transmits a wearing state signal via the communication module 22 and the DTV 1 perform image quality adjustments in response to the wearing state signal. This configuration allows the DTV 1 to perform suitable image quality adjustments when the wearing state of the shutter glasses 2 of the user has changed.

In the embodiment, since the DTV 1 has the image quality setting table 310 and the image quality adjusting module 309 controls the image quality adjustment amounts based on the image quality setting table 310, the processing of controlling the image quality adjustment amounts can be performed with a small processing amount.

The DTV 1 according to the embodiment performs image quality adjustments that are suitable for each user viewing form and thereby presents the user with video that is close to source video. As such, even when the user has changed the viewing form, the DTV 1 can present the user with video having almost no changes in image quality from video before the viewing form change.

The DTV 1 according to the embodiment allows the user to view video that is suitable for a current viewing foam without consuming time and labor to make image quality adjustments by himself or herself.

Furthermore, the DTV 1 according to the embodiment can output vide whose image quality is suitable for a current video viewing form of the user.

While certain embodiments have been described, these embodiments have been presented by way of example only, and are not intended to limit the scope of the invention. Indeed, the novel apparatus, method and system described herein may be embodied in a variety of other forms; furthermore, various omissions, substitutions and changes in the form of the apparatus, method and system described herein may be made without departing from the sprit of the invention. The accompanying claims and their equivalents are intended to cover such forms or modifications as would fall within the scope and sprit of the invention.

What is claimed is:

1. An electronic apparatus comprising:
a video output module configured to output 2D video and 3D video selectively;
a receiving module configured to receive a wearing state signal indicating whether or not a user wears shutter glasses; and
an image quality adjusting module configured to determine a first image quality adjustment amount when the video output module outputs the 2D video and the wearing state signal indicates that the user wears the shutter glasses, and to determine a second image quality adjustment amount when the video output module outputs the 2D video and the wearing state signal indicates that the user does not wear the shutter glasses,
wherein the second image quality adjustment amount is different from the first image quality adjustment amount.

2. The apparatus of claim 1,
wherein the image quality adjusting module is configured to determine a third image quality adjustment amount when the video output module outputs the 3D video, and
wherein the first image quality adjustment amount, the second image quality adjustment amount and the third image quality adjustment amount are different one another.

3. The apparatus of claim 1, further comprising:
a transmitting module configured to transmit the shutter glasses a signal for requesting transmission of the wearing state signal.

4. The apparatus of claim 1,
wherein when the receiving module receives the wearing state signal while the video outputting module is outputting the 2D video, the image quality adjusting module determines the image quality adjustment amount for the output 2D video based on the wearing state signal.

5. The apparatus of claim 1, further comprising:
a storage module configured to store an image quality setting table which comprises values to be used for determining the image quality adjustment amount,
wherein the image quality adjusting module is configured to determine the image quality adjustment amount for the output 2D video based on the values.

6. The apparatus of claim 5, further comprising:
an altering module configured to alter the values of the image quality setting table.

7. The apparatus of claim 1,
wherein the image quality adjusting module is configured to determine a first white balance adjustment amount when the video output module outputs the 2D video and the wearing state signal indicates that the user wears the shutter glasses, and to determine a second white balance adjustment amount when the video output module outputs the 2D video and the wearing state signal indicates that the user does not wear the shutter glasses, and
wherein the second white balance adjustment amount is different from the first white balance adjustment amount.

8. The apparatus of claim 1,
wherein the image quality adjusting module is configured to determine a first sharpness adjustment amount when the video output module outputs the 3D video, and to determine a second sharpness adjustment amount when the video output module outputs the 2D video, and
wherein the second sharpness adjustment amount is different from the first sharpness adjustment amount.

9. The apparatus of claim 1, further comprising:
a display module configured to display the video that is output from the video output module; and
a shutter control signal transmitting module configured to transmit a shutter control signal for shutters to the shutter glasses.

10. A video output system comprising:
shutter glasses comprising
a shutter control signal receiving module configured to receive a shutter control signal for shutters,
a driving module configured to drive the shutters based on the shutter control signal,
a detecting module configured to detect whether or not a user wears the shutter glasses, and
a transmitting module configured to transmit a wearing state signal indicating whether or not the user wears the shutter glasses based on a detection result of the detecting module; and
an electronic apparatus comprising
an video output module configured to output 2D video and 3D video selectively;
a transmitting module configured to transmit the shutter control signal in synchronism with frame updating of the output 3D video when the video output module is outputting the 3D video,
a receiving module configured to receive the wearing state signal that is transmitted from shutter glasses, and
an image quality adjusting module configured to determine a first image quality adjustment amount when the video output module outputs the 2D video and the wearing state signal indicates that the user wears the shutter glasses, and to determine a second image quality adjustment amount when the video output module outputs the 2D video and the wearing state signal indicates that the user does not wear the shutter glasses,
wherein the second image quality adjustment amount is different from the first image quality adjustment amount.

11. A video output method comprising:
outputting 2D video and 3D video selectively;
receiving a wearing state signal indicating whether or not a user wears shutter glasses; and
determining a first image quality adjustment amount when the 2D video is output and the wearing state signal indicates that the user wears the shutter glasses, and to determine a second image quality adjustment amount when the 2D video is output and the wearing state signal indicates that the user does not wear the shutter glasses,
wherein the second image quality adjustment amount is different from the first image quality adjustment amount.
